(19) United States
(12) Patent Application Publication
(10) Pub. No.: US 2025/0206191 A1
(43) Pub. Date: Jun. 26, 2025

(54) METHOD AND SYSTEM FOR BATTERY CELL CHARGE BALANCING

(71) Applicant: GM GLOBAL TECHNOLOGY OPERATIONS LLC, DETROIT, MI (US)

(72) Inventors: Zach Allen Golm, Farmington Hills, MI (US); Brendan Greenberg, Warren, MI (US); Garrett Michael Seeman, Clawson, MI (US); Alex Michael Cannizzaro, Rochester, MI (US)

(21) Appl. No.: 18/391,853

(22) Filed: Dec. 21, 2023

(51) Int. Cl. B60L 58/22; B60L 58/12; H01M 10/42; H01M 10/44; H01M 10/48; H01M 50/51

(52) U.S. Cl. CPC B60L 58/22; B60L 58/12; H01M 10/425; H01M 10/441; H01M 10/482; H01M 50/51; H01M 2010/4271; H01M 2220/20

(57) ABSTRACT

Embodiments include methods and systems for charge balancing in a battery system having a string of battery packs that each include a plurality of battery cells. Aspects include obtaining electrical parameters for each of the plurality of battery cells and calculating a battery pack balance point for each of the battery packs in the string. Aspects also include instructing a cell balancing system to execute a cell charge balancing routine to balance each of the plurality of battery cells of each battery pack to the battery pack balance point corresponding to the battery pack, calculating a string balance point for the string of battery packs based on the battery pack balance points, and instructing the cell balancing system of each battery pack to balance the plurality of battery cells of the battery pack to the string balance point.

### INTRODUCTION

The disclosure relates to charge balancing of battery cells in an electric vehicle. More specifically, the disclosure relates to performing charge balancing across multiple batteries that each includes a plurality of cells.

Batteries are electrochemical devices that may include multiple cells that are electrically interconnected to provide electric power to a device, such as an electric machine. In use, battery cells may develop different electrical characteristics that may be quantified in terms of charge capacities, states of charge, discharge rates, impedances, and/or voltages. Furthermore, one or more of the cells of a battery may be replaced and/or added in use, resulting in different capacities, states of charge, discharge rates, impedances, and/or voltages between the new battery cell and the existing battery cells. An imbalance in electrical characteristics between battery cells may affect the performance characteristics and service life of a multi-cell battery. Properly balancing battery cells may prevent overcharging and/or undercharging of individual cells and may maximize usable battery energy.

Vehicles may include one or multiple batteries for operating a vehicle's electrical and/or drivetrain systems. For example, a vehicle may include a 12V lead-acid automotive battery configured to supply electric energy to vehicle starter systems (e.g., a starter motor), lighting systems, and/or ignition systems. Furthermore, electric vehicles and hybrid vehicles may include a high-voltage battery to provide power to electric drivetrain components such as electric drive motors.

Long periods of battery rest time, (i.e., periods of operation at low or no current), may be required to determine amounts of charge that are to be removed from cells having high levels of state of charge to achieve a balanced state in the battery. A vehicle operating in an autonomous mode may be operating continuously, making the occurrence of long periods of rest time unlikely. There may be a need to evaluate in-process cell charge balancing calculations in order to ensure that the most accurate information is employed in cell balancing in the battery.

### SUMMARY

In one exemplary embodiment, a method for charge balancing in a battery system having a string of battery packs that each include a plurality of battery cells is provided. The method includes obtaining electrical parameters for each of the plurality of battery cells, calculating a battery pack balance point for each of the battery packs in the string, and instructing a cell balancing system to execute a cell charge balancing routine to balance each of the plurality of battery cells of each battery pack to the battery pack balance point corresponding to the battery pack. The method also includes calculating a string balance point for the string of battery packs based on the battery pack balance points and instructing the cell balancing system of each battery pack to balance the plurality of battery cells of the battery pack to the string balance point.

In addition to the one or more features described herein the battery packs of the string are connected to one another in series.

In addition to the one or more features described herein each battery pack includes a battery pack controller and wherein the battery pack controller is configured to calculate the battery pack balance point for the battery pack.

In addition to the one or more features described herein the battery pack controller of each battery pack is configured to transmit the battery pack balance point for the battery pack to the battery pack controllers of other battery packs in the string.

In addition to the one or more features described herein the battery pack controller of each battery pack is configured to transmit the battery pack balance point for the battery pack to a string controller associated with the string.

In addition to the one or more features described herein the string controller is configured to calculate the string balance point for the string of battery packs based on the battery pack balance points and to transmit the string balance point to the battery pack controllers.

In addition to the one or more features described herein the battery pack controller of each battery pack is configured to transmit the battery pack balance point for the battery pack to a central battery system controller, wherein the central battery system controller is configured to calculate the string balance point for the string of battery packs based on the battery pack balance points.

In one exemplary embodiment, a battery system is provided. The battery system includes a plurality of strings, each of the plurality of strings including a plurality of battery packs connected to one another in series. Each of the plurality of battery pack includes a plurality of battery cells, sensors configured to monitor electrical parameters of each of the plurality of battery cells, a cell balancing system configured to selectively charge or discharge the plurality of battery cells of the battery pack, and a battery pack controller configured to monitor the electrical parameters for each of the plurality of battery cells and to responsively control operation of the cell balancing system. The battery pack controller is further configured to calculate a battery pack balance point based on the electrical parameters of each of the plurality of battery cells.

In addition to the one or more features described herein the battery system also includes a central battery system controller that is configured to communicate with the battery pack controller of each of the battery packs of the plurality of strings.

In addition to the one or more features described herein the central battery system controller is configured to calculate a string balance point for each of the plurality of strings of battery packs based on the battery pack balance points and to transmit a corresponding string balance point to the battery pack controller of each battery pack.

In addition to the one or more features described herein the battery pack controller of each battery pack is configured to the cell balancing system of each battery pack to balance the plurality of battery cells of the battery pack to the string balance point.

In addition to the one or more features described herein the battery system also includes a string controller associated with one of the plurality of strings, wherein the string controller is configured to communicate with the battery pack controller of each of the battery packs of the one of the plurality of strings.

In addition to the one or more features described herein the string controller is configured to calculate a string balance point for the one of the plurality of strings and to transmit the string balance point to the battery pack controller of each battery pack of the one of the plurality of strings.

In addition to the one or more features described herein the battery pack controller of each battery pack is configured to the cell balancing system of each battery pack to balance the plurality of battery cells of the battery pack to the string balance point.

In addition to the one or more features described herein the battery pack controller of each battery pack of one of the plurality of strings is configured to transmit the battery pack balance point to the battery pack controllers of other battery packs in one of the plurality of strings.

In one exemplary embodiment, an electric vehicle is provided. The electric vehicle includes a battery system having a plurality of strings, each of the plurality of strings including a plurality of battery packs connected to one another in series. Each of the plurality of battery pack includes a plurality of battery cells, sensors configured to monitor electrical parameters of each of the plurality of battery cells, a cell balancing system configured to selectively charge or discharge the plurality of battery cells of the battery pack, and a battery pack controller configured to monitor the electrical parameters for each of the plurality of battery cells and to responsively control operation of the cell balancing system. The battery pack controller is further configured to calculate a battery pack balance point based on the electrical parameters of each of the plurality of battery cells.

In addition to the one or more features described herein the battery system further includes a central battery system controller that is configured to communicate with the battery pack controller of each of the battery packs of the plurality of strings.

In addition to the one or more features described herein the central battery system controller is configured to calculate a string balance point for each of the plurality of strings of battery packs based on the battery pack balance points and to transmit a corresponding string balance point to the battery pack controller of each battery pack.

In addition to the one or more features described herein the battery pack controller of each battery pack is configured to the cell balancing system of each battery pack to balance the plurality of battery cells of the battery pack to the string balance point.

In addition to the one or more features described herein the battery system further includes a string controller associated with one of the plurality of strings, wherein the string controller is configured to communicate with the battery pack controller of each of the battery packs of the one of the plurality of strings.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1A is a schematic diagram of an electric vehicle in accordance with an exemplary embodiment;

FIG. 1B is a schematic diagram of a battery system of an electric vehicle in accordance with an exemplary embodiment;

FIG. 1C is a schematic diagram of a battery system of an electric vehicle in accordance with an exemplary embodiment;

FIG. 1D is a schematic diagram of a battery system of an electric vehicle in accordance with an exemplary embodiment;

FIG. 2 graphically shows data associated with individual cell voltages, in accordance with an exemplary embodiment;

FIG. 3 schematically shows, in flowchart form, a process for executing a charge balancing routine based upon first and second quality indices, in accordance with an exemplary embodiment;

FIGS. 4-1 through 4-6 graphically show quality indices in relation to corresponding parameters, in accordance with an exemplary embodiment; and

FIG. 5 schematically shows, in flowchart form, a method for performing charge balancing across multiple battery packs that each includes a plurality of cells in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings.

These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

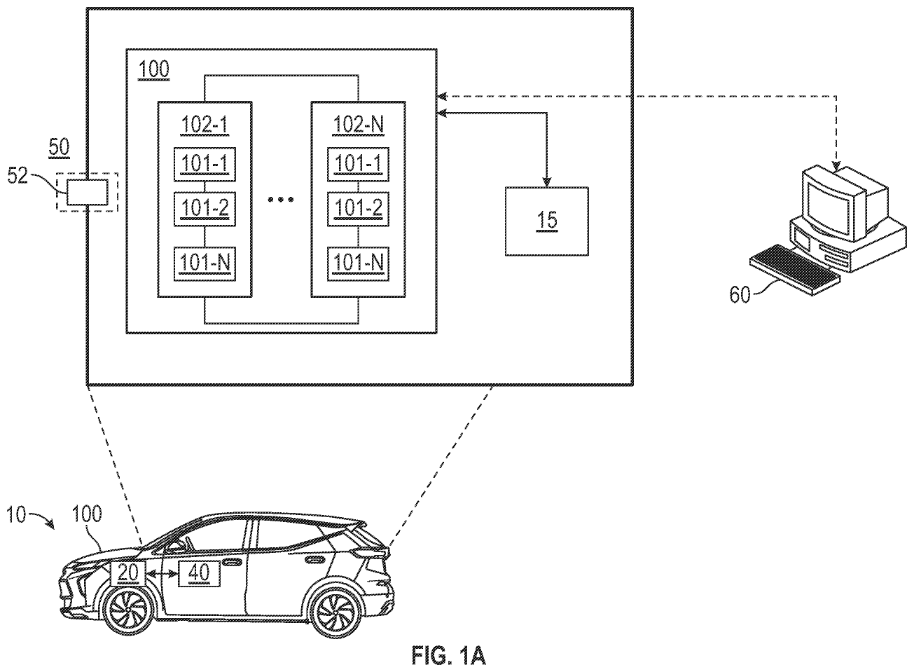

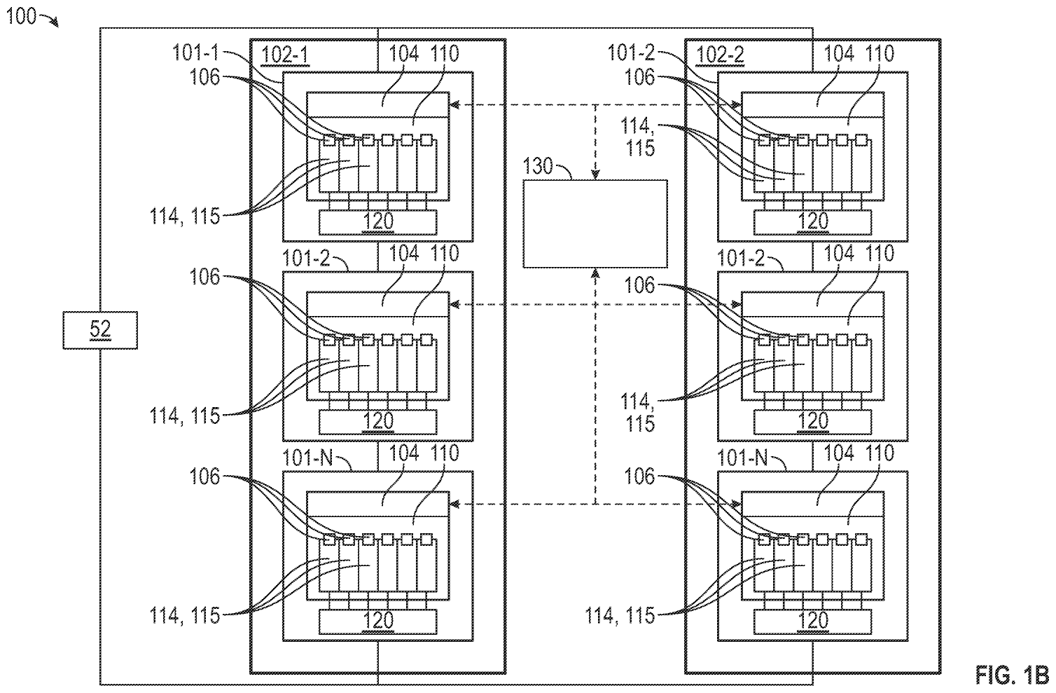

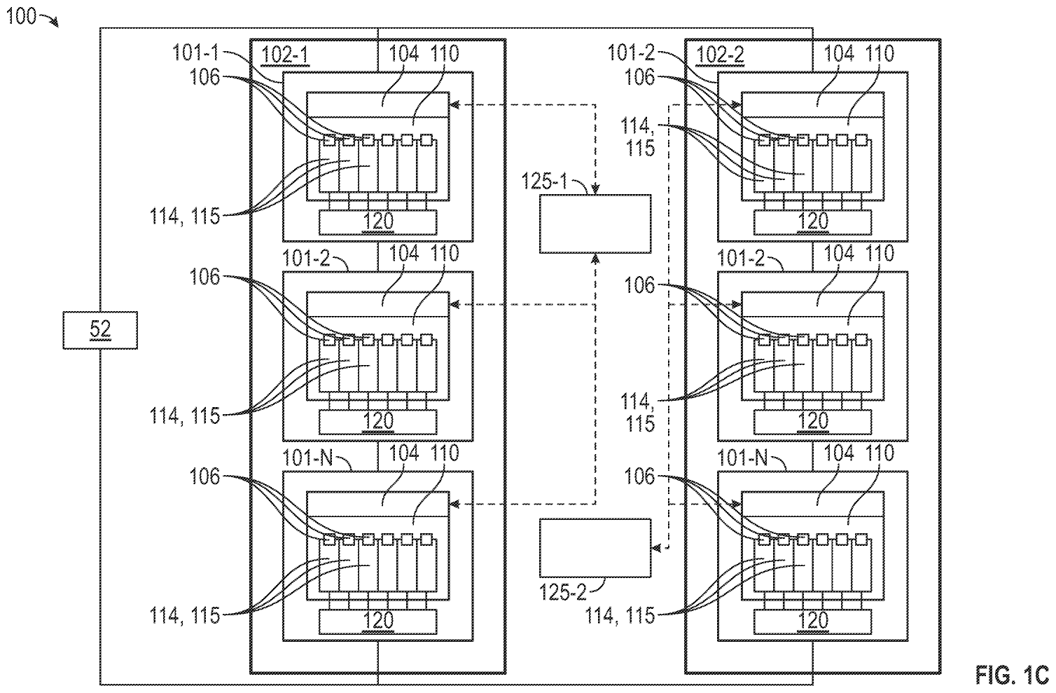

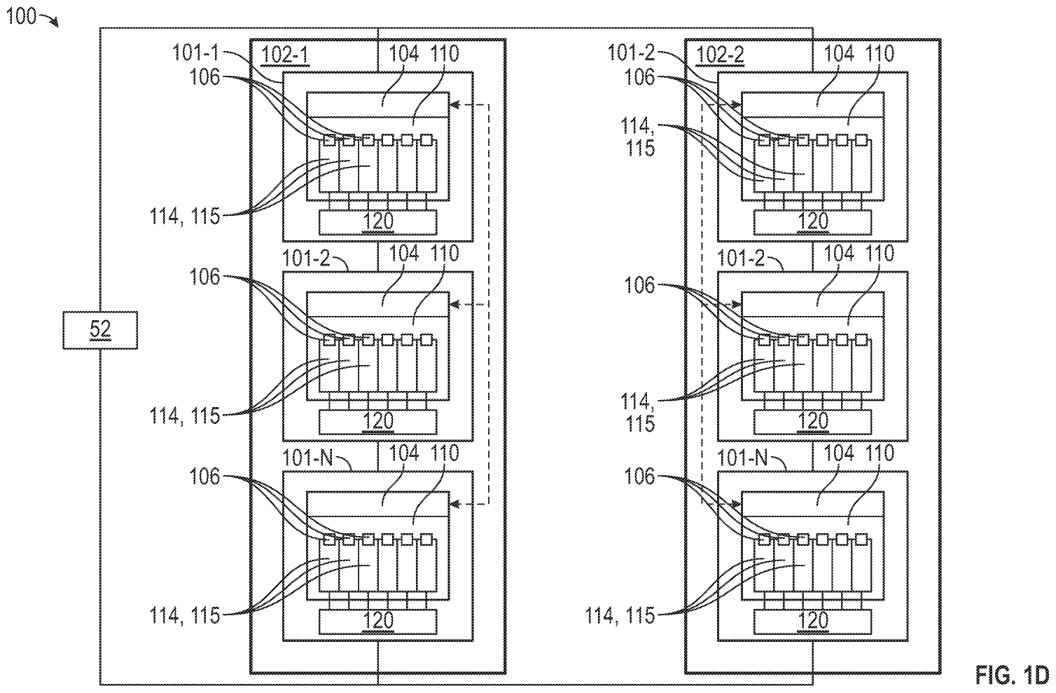

Referring now to FIGS. 1A through 1D, a vehicle 10 that includes a drivetrain 20 and a battery system 100 in accordance with exemplary embodiments are shown. Overarching operation of the vehicle 10 is controlled by a vehicle controller 15. In one embodiment, the vehicle 10 also includes an autonomic vehicle control system 40. In another embodiment, the vehicle 10 may be configured as a non-autonomous vehicle that is manually controlled by an operator. The vehicle 10 includes, in one embodiment, a four-wheel passenger vehicle with steerable front wheels and fixed rear wheels. The vehicle 10 may include, by way of non-limiting examples, a passenger vehicle, a light-duty or heavy-duty truck, a utility vehicle, an agricultural vehicle, an industrial/warehouse vehicle, a recreational off-road vehicle, an airplane, or a marine vehicle.

The drivetrain 20 of the vehicle 10 may be configured as an electric vehicle (EV), a hybrid vehicle (HV) that includes an internal combustion engine (“ICE”), or another configuration that incorporates the systems and methods disclosed herein. The battery system 100 may be employed to supply electric power to electrical components of the drivetrain 20.

The autonomic vehicle control system 40 includes an on-vehicle control system that is capable of providing a level of driving automation. The terms ‘driver’ and ‘operator’ describe the person responsible for directing operation of the vehicle 10, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the vehicle. Driving automation can include some level of automatic control or intervention related to simultaneous control of multiple vehicle functions, such as steering, acceleration, and/or braking, with the driver continuously having overall control of the vehicle. Driving automation can include simultaneous automatic control of all vehicle driving functions, including steering, acceleration, and braking, wherein the driver cedes control of the vehicle for a period of time during a trip. Driving automation can include simultaneous automatic control of vehicle driving functions, including steering, acceleration, and braking, wherein the driver cedes control of the vehicle for an entire trip. Driving automation includes hardware and controllers configured to monitor the spatial environment under various driving modes to perform various driving tasks during dynamic operation. Driving automation can include, by way of non-limiting examples, cruise control, adaptive cruise control, lane-change warning, intervention and control, automatic parking, acceleration, braking, and the like.

The vehicle 10 includes an electrical charging system 50 for electrically charging battery cells 115 of the battery system 100. In one embodiment, the electrical charging system 50 includes a charger 52 that is electrically couplable to an off-vehicle electrical power supply (not shown) that may be available at a public or private charging station. The electrical power supply may be arranged to supply electrical power to charge the battery system 100 via the electrical charging system 50. The supplied electrical power may be in the form of alternating current (AC) power or direct current (DC) power.

In exemplary embodiments, the battery system 100 includes one or more strings 102-1, 102-2 (referred to collectively herein as strings 102) of battery modules 101-1, 101-2, 102-N (referred to collectively herein as battery modules 101). In exemplary embodiments, the strings 102 of the battery system 100 are connected to one another in parallel and the battery modules 101 of each string 102 are connected to one another in series. Although only two strings 102-1, 102-2 are illustrated, it will be appreciated by those of ordinary skill in the art that the number of strings 102 may be more or less than the illustrated embodiment.

In exemplary embodiments, as illustrated in FIGS. 1B, 1C, and 1D, each battery module 101 includes a battery pack 110, a battery pack controller 104, a plurality of sensors 106, and a cell balancing system 120. The battery pack 110 may be arranged as a multi-cell high-voltage battery system including a plurality of the battery cells 115 that are electrically connected in series or in parallel to provide electrical power to an actuator, such as an electric machine. The battery cells 115 may be arranged in one or more battery sections 114 that are sized to provide electrical power at a desired voltage and a desired current to a system of vehicle 10, (e.g., the drivetrain 20). Each of the battery cells 115 may employ rechargeable electrochemical battery technology including, for example, lead-acid, nickel-metal hydride (“NiMH”), lithium-ion (“Li-Ion”), Li-Ion polymer, lithium-air, nickel-cadmium (“NiCad”), valve-regulated lead-acid (“VRLA”) including absorbed glass mat (“AGM”), nickel-zinc (“NiZn”), molten salt (e.g., a ZEBRA battery), and/or other battery technologies.

The sensors 106 are configured to measure electrical parameters associated with the battery cells 115. In one embodiment, each of the sensors 106 is a voltmeter or an ammeter. Individual ones of the sensors 106 may be associated with each of the battery cells, or with each of the battery sections 114. State of charge information may be determined based on the measured electrical parameters from the sensors 106. The determined state of charge may be provided to the battery pack controller 104. Using the state of charge information, the battery pack controller 104 may operate to coordinate battery balancing operations.

Each of the battery cells 115, or battery sections 114, may be in communication with a cell balancing system 120. The cell balancing system 120 may include a network of switches and/or gates that are configured to facilitate selective electrical energy transfer to, from, and/or between the battery cells 115. The cell balancing system 120 is configured to balance the battery cells 115 of the battery pack 110 by charging individual ones of the battery cells 115 and/or discharging individual ones of the battery cells 115, such that each of the battery cells 115 has the same or similar quantum of energy stored therein, as indicated by a state of charge measurement or a voltage measurement.

The battery system 100 includes the battery pack controller 104, which is configured to monitor and control certain operations of the battery pack 110. For example, the battery pack controller 104 may be configured to monitor information from the plurality of sensors 106 and control operations of the electrical charging system 50 and the cell balancing system 120 to control charging, discharging, and/or balancing operations of the battery pack 110. The battery pack controller 104 may further be configured to provide information to and/or receive information from other systems included in the vehicle 10. For example, the battery pack controller 104 may be communicatively coupled with the vehicle controller 15 and/or a remotely located external computer system 60 via a telematics system (not shown). In certain embodiments, the battery pack controller 104 may be configured, at least in part, to provide information regarding the battery pack 110 to a user of the vehicle 10, the vehicle controller 15, and/or the external computer system 60. Such information may include, for example, battery state of charge information, battery operating time information, battery operating temperature information, and/or other information regarding the battery pack 110.

In certain embodiments, a cell charge balancing operation may be performed upon startup of the vehicle 10. In other embodiments, a cell charge balancing operation may be performed when the vehicle 10 and/or battery system 100 are not in use. In further embodiments, a cell charge balancing operation may be performed upon the installation of a new battery cell 115 and/or the replacement of an old battery cell 115. Battery cells 115 of the battery pack 110 are said to be balanced, or in a balanced state when the estimated states of charge and/or the calculated quanta of energy are within an allowable range of error.

Cell charge balancing may begin by determining the states of charge of each of the battery cells 115 within a battery pack 110. Voltages of each of the battery cells 115 may be employed as indicators of the states of charge. A quantum of energy to reach a desired state of charge balance point for the battery system may be calculated for each of the plurality of sections. In certain embodiments, a quantum of energy may be expressed in terms of ampere-hours (“AHr”) required to reach the desired state of charge balance point. Based on the estimated states of charge and/or the calculated quanta of energy, it may be determined that the battery cells 115 are either balanced or unbalanced. For example, if the estimated states of charge and/or the calculated quanta of energy are equivalent, within an allowable range of error, it may be determined that the battery cells 115 are balanced. If the battery cells 115 within a battery pack 110 are balanced, cell charge balancing operations may not be required. If, however, the battery cells 115 within a battery pack 110 are unbalanced or if battery cells 115 of different battery packs within a string 102 are unbalanced, balancing operations may proceed.

By way of example, one or more battery cells 115 may be identified as having calculated quanta of energy (e.g., calculated in terms of AHr) required to reach the desired state of charge balance point that is different (e.g., greater or smaller) than other battery cells 115. For example, in a battery pack 110 having three battery cells 115, a first cell and a second cell may be associated with the same quantum of energy required to reach a desired balance point (e.g., 20 AHr). A third battery cell may be associated with a smaller quantum of energy required to reach the desired balance point (e.g., 15 AHr). In one embodiment, the third cell may be discharged (e.g., by 5 AHr) so that all three battery cells 115 require the same quantum of energy (e.g., 20 AHr) to reach a desired state of charge balancing point. In this manner, upon charging the battery system 100 to the desired state of charge balancing point (e.g., a charge termination level), all battery cells 115 of the battery system 100 will be at or near the balancing point and the battery system 100 will be balanced.

In exemplary embodiments, each battery pack 110 is configured to perform a balancing algorithm to identify a battery pack balance point and to balance the battery cells 115 within the battery pack 110. In addition, once each battery pack 110 has determined the battery pack balance point for the battery pack 110, the battery pack controller 104 of the battery pack 110 communicates with, and provides the battery pack balance point to, one of a central battery system controller 130 (as shown in FIG. 1B), a string controller 125 (as shown in FIG. 1C), or the battery pack controller 104 of the other battery packs 110 of the string 102 (as shown in FIG. 1D). As a result, a string balancing point for all of the battery packs 110 in a string 102 can be determined. Once the string balancing point is determined and communicated to the battery pack controllers 104, the battery pack controllers 104 instruct the cell balancing systems 120 to effect cell charge balancing in the battery pack 110 to bring all of the battery cells 115 to the string balancing point.

In one embodiment, as shown in FIG. 1B, the battery pack controllers 104 of each battery pack 110 are configured to communicate with a central battery system controller 130. In exemplary embodiments, the central battery system controller 130 is configured to receive a battery pack balancing point from the battery pack controllers 104 of each battery pack 110 in the battery system 100. The central battery system controller 130 is also configured to calculate a string balancing point for each string 102 based on the battery pack balancing points of each battery pack 110 in the string 102. Once the string balancing point is calculated, the central battery system controller 130 provides the string balancing point to each of the battery pack controllers 104. In exemplary embodiments, the battery pack controller 104 responsively instructs the cell balancing system 120 to effect cell charge balancing in the battery pack 110 to bring all of the battery cells 115 to the string balancing point.

In another embodiment, as shown in FIG. 1C, the battery pack controllers 104 of each battery pack 110 of a string 102 are configured to communicate with a string controller 125 associated with the string 102. For example, string controller 125-1 is configured to communicate with the battery pack controllers of the battery packs 110 in string 102-1. Likewise, string controller 125-2 is configured to communicate with the battery pack controllers of the battery packs 110 in string 102-2. In exemplary embodiments, each string controller 125 is configured to receive the battery pack balancing point from the battery pack controllers 104 of each battery pack 110 in the corresponding string 102. The string controller 125 is configured to calculate a string balancing point for the string 102 based on the battery pack balancing points of each battery pack 110 in the string 102. Once the string balancing point is calculated, string controller 125 provides the string balancing point to each of the battery pack controllers 104. In exemplary embodiments, the battery pack controller 104 responsively instructs the cell balancing system 120 to effect cell charge balancing in the battery pack 110 to bring all of the battery cells 115 to the string balancing point.

In a further embodiment, as shown in FIG. 1D, the battery pack controllers 104 of each battery pack 110 of a string 102 are configured to communicate directly with the other battery pack controllers 104 of the battery modules 101 within the string 102. In exemplary embodiments, each battery pack controller 104 is configured to calculate a battery pack balancing point and to transmit the battery pack balancing point to other battery pack controllers 104 in the same string. In exemplary embodiments, when a battery pack controller 104 receives an indication that another battery pack 110 has a lower battery pack balancing point, the battery pack controller 104 responsively instructs the cell balancing systems 120 to effect cell charge balancing in the battery pack 110 to bring all of the battery cells 115 to the newly received balancing point.

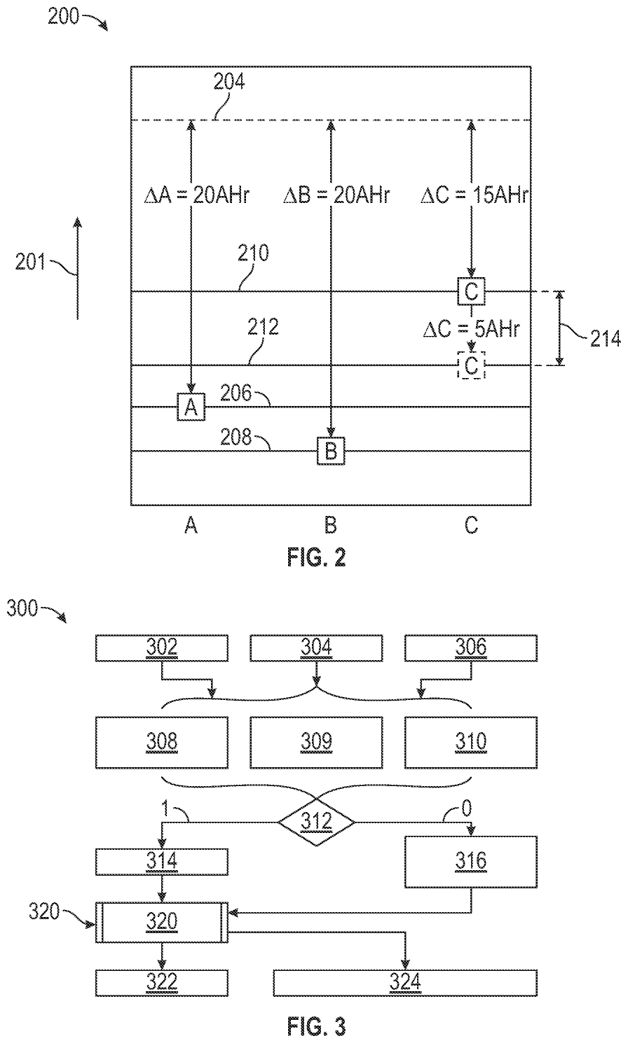

FIG. 2 is a conceptual graph illustrating methods for balancing a battery pack in accordance with embodiments disclosed herein, and graphically shows voltage data associated with individual battery cells 115 for an embodiment of the battery pack 110. A target open-circuit voltage (OCV) 212, an actual OCV 210, and a voltage reduction 214 are indicated for each of the battery cells. The voltage data 201 is an example of a battery assessment that may be employed by a cell charge balancing routine 320, as described with reference to FIG. 3. The graph of FIG. 2 illustrates a state of charge window representing varied states of charge 200 for a plurality of battery cells 202 (e.g., cells A, B and C) under three different states of charge conditions. For example, Cell A may have a first state of charge 206, Cell B may have a second state of charge 208, and Cell C may have a third state of charge 212.

A quantum of energy to reach a desired state of charge balance point 204 for the battery system may be calculated for each of the battery cells 202. In certain embodiments, a quantum of energy may be expressed in terms of ampere-hours (“AHr”) required to reach the desired state of charge balance point 204 that, in certain embodiments, may be a charge termination level for the battery system. For example, as illustrated, Cell A may be associated with a quantum of energy (ΔA) of 20 AHr, Cell B may be associated with a quantum of energy (ΔB) of 20 AHr, and Cell C may be associated with a quantum of energy (ΔC) of 15 AHr. In certain, embodiments, two or more of the cells may require the same quanta of energy to reach the state of charge balance point 204 but nevertheless have different associated states of charge due to different cell capacities, (e.g., Cells A and Cell B). In further embodiments, cells having the same states of charges may be associated with the same quanta of energy to reach the state of charge balance point 204.

Based on the states of charge 206-210 and/or the calculated quanta of energy, (e.g., ΔA, ΔB, and ΔC), it may be determined that the battery cells 202 are either balanced or unbalanced. For example, if the estimated states of charge 206-210 and/or the calculated quanta of energy are equivalent, within a predefined range, it may be determined that the battery cells 202 are balanced. If the battery cells 202 are balanced, balancing operations may not be required. If, however, the battery cells 202 are unbalanced, as illustrated in FIG. 2, balancing operations may proceed. One or more battery cells may be identified as having calculated quanta of energy required to reach the desired state of charge balance point 204 that are different, (e.g., greater or less than other battery cells). For example, as illustrated, Cell C may have an associated quantum of energy, (e.g., ΔC=15 Ahr), that is different from the quanta of energy associated with Cell A and Cell B, (e.g., ΔA. and ΔB) being approximately 20 AHr. Cell A, Cell B, and/or Cell C may then be charged and or discharged such that the quanta of energy associated with the cells are the same or similar, (e.g., ΔA and. ΔB) being approximately equal to ΔC, (e.g., 20 Ahr)). For example, as illustrated, Cell C may be discharged by a quantum of energy (ΔC) of 5 AHr to the state of charge level 212 such that the quanta of energy associated with the cells are the same or similar, (e.g., ΔA being approximately equal to ΔB being approximately equal to ΔC), which is approximately equal to 20 AHr. In this manner, upon charging the battery pack to the desired state of charge balancing point 204, all cells 202 of the battery pack will be at or near the balancing point 204 and the battery pack will be balanced.

Referring now to FIG. 3, with continued reference to the battery system 100 that is described with reference to FIG. 1A-1D, a cell charge balancing control routine 300 is schematically illustrated. The cell charge balancing control routine 300 may be executed by the battery pack controller 104 to monitor the battery pack 110 via the plurality of sensors 106, and control the operation of the cell balancing system 120 to effect cell charge balancing in the battery pack 110. The cell charge balancing control routine 300 is illustrated as a collection of blocks in a logical flow graph, which represents a sequence of operations that can be implemented in hardware, software, firmware, or a combination thereof that have been configured to perform the specific functions. In the context of software, the blocks represent computer instructions that, when executed by one or more processors, perform the recited operations. During operation of the vehicle 10, the battery pack controller 104 monitors the sensors 106 associated with each of the battery cells 115 of the battery pack 110 and periodically communicates with the electrical charging system 50 to perform a battery assessment that may be employed by a cell charge balancing routine 320.

In one embodiment, the battery pack controller 104 may be triggered to perform a battery assessment that may be employed by the cell charge balancing routine 320 when the battery pack 110 has achieved a rested state at block 302. A rested state for the battery pack 110 may be defined as the battery pack 110 being at a zero-current state for an extended period of time, (e.g., greater than 4 hours). When the battery pack 110 has achieved the rested state, electrical parameters for each of the battery cells 115 may be determined employing the plurality of sensors 106.

In another embodiment, the battery pack controller 104 may be triggered to perform a battery assessment that may be employed by the cell charge balancing routine 320 when the battery is being operated at a low current state at block 304. A low current state for the battery pack 110 may be defined as the battery pack 110 being at a current level that is less than 10 amps for an extended period of time, (e.g., greater than 0.5 hours). When the battery pack 110 has achieved the low-current state, electrical parameters for each of the battery cells 115 may be determined employing the plurality of sensors 106.

In a further embodiment, the battery pack controller 104 may be triggered to perform a battery assessment that may be employed by the cell charge balancing routine 320 when the battery pack 110 is at a charge complete state at block 306. A charge complete state for the battery pack 110 may be defined as occurring immediately subsequent to discontinuation or an end of a charging event for the battery pack 110, and may include the battery pack 110 being fully charged, or the battery pack 110 being partially charged. When the battery pack 110 has achieved the charge complete state, electrical parameters for each of the battery cells 115 may be determined employing the plurality of sensors 106.

When one of the aforementioned conditions at blocks 302, 304, or 306 triggers the battery pack controllers 104 to perform a battery assessment for potential use by the cell charge balancing routine 320, the electrical parameters for each of the battery cells 115 are captured and determined employing the plurality of sensors 106. In one embodiment, and as described with reference to FIG. 2, the electrical parameters for each of the battery cells 115 may be in the form of a voltage for each of the battery cells 115. Furthermore, a temperature of the battery pack 110 may be determined.

The cell charge balancing control routine 300 determines a quality index Q based upon the electrical parameters for each of the battery cells 115 and the temperature of the battery pack 110 that are captured at the time when one of the aforementioned conditions triggers the battery pack controller 104 to perform the battery assessment for potential use by the cell charge balancing routine 320 at block 308. The new quality index Q_{new} may be determined in accordance with the following equation. Q_{new}=Q_{cellV}*Max(Q_{oct}, Q_{low curr t}, Q_{cc}), where Q_{new} represents a quality index associated with the new event, Q_{cellV} represents a cell voltage quality index, Q_{oct} represents an open circuit time quality index, Q_{low curr t}, represents a low current quality index, and Q_{cc} represents a charge complete event quality index.

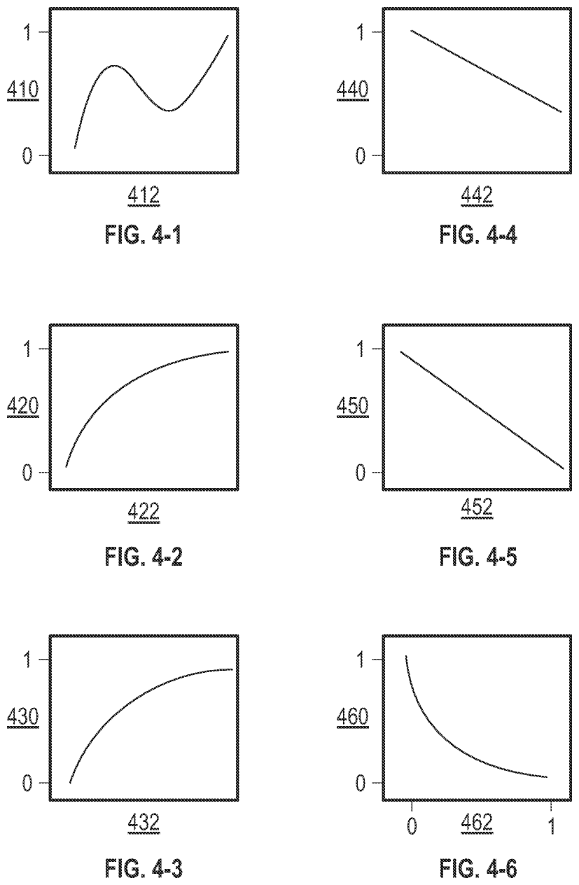

In one embodiment, the cell voltage quality index, Q_{cellV}, is determined in relation to the cell voltage and the battery temperature, and is an indication of several factors including but not limited to flatness of the OCV/SOC relationship, areas of high voltage hysteresis, and difference from the balance point target which can induce error in balancing calculations from capacity measurement error. Some of the influences on quality listed can be predetermined and defined as a fixed calibration, while others may be empirically determined in real-time in the battery pack controller 104. FIG. 4-1 graphically shows a relationship between the cell voltage quality index, Q_{cellV} 410, and the voltage level 412, including a low voltage V_{low} and a target voltage V_{tgt}, at a known battery temperature.

In one embodiment, the open circuit time quality index Q_{oct} is determined in relation to the open circuit time and the battery temperature, and is an indication of the elapsed period of time at which the battery pack 110 has been maintained in an open circuit state prior to capturing the electrical parameters for each of the battery cells 115 and the temperature of the battery pack 110, (i.e., has been rested). The open circuit time quality index Q_{oct} increases with an increase in the elapsed period of time because the accuracy of the electrical parameters for each of the battery cells 115 increases over time. FIG. 4-2 graphically shows a relationship between the open circuit time quality index Q_{oct} 420 and time at the open circuit condition 422, at a known battery temperature.

In one embodiment, the low current quality index Q_{low curr t} is determined in relation to the low current time and the battery temperature, and is an indication of the elapsed period of time at which the battery pack 110 has been maintained in a low current state prior to capturing the electrical parameters for each of the battery cells 115 and the temperature of the battery pack 110. The low current quality index Q_{low curr t} increases with an increase in the elapsed period of time because the accuracy of the electrical parameters for each of the battery cells 115 increases over time. FIG. 4-3 graphically shows a relationship between the low current quality index Q_{low curr t} 430 and time at the low current condition 432, at a known battery temperature.

In one embodiment, the charge complete event quality index Q_{cc} is determined in relation to the occurrence of a charge complete event, and is an indication of long periods of unidirectional current going into the battery pack 110. The charge complete event quality index Q_{cc} increases with a decrease in the charge current or power provided via charger 52 because the accuracy of the electrical parameters for each of the battery cells 115 decreases therewith. FIG. 4-4 graphically shows a relationship between the charge complete event index Q_{cc} 440 and charge power 442 that is provided via charger 52, at a known battery temperature.

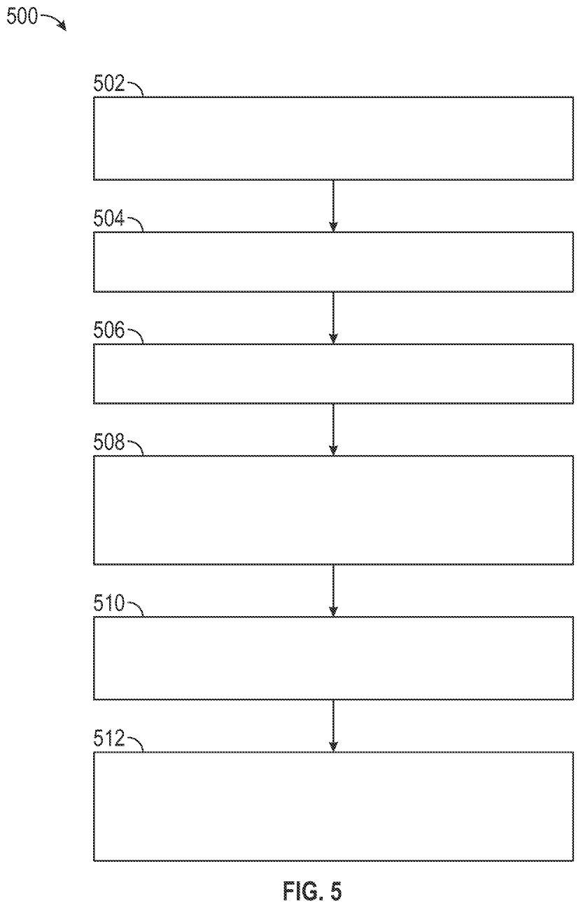

An existing quality index Q_{old} represents a quality index that was determined at a previous timepoint, when one of the aforementioned conditions triggers the electrical charging system 50 to perform a battery assessment for use by the cell charge balancing routine at block 310. The existing quality index Q_{old} is initially set to zero, and is reset to zero when the cell balancing operation is completed. The existing quality index Q_{old} is determined by subjecting a previously determined quality index Q_{new}(t−1) to a decaying factor Q_{decay}. The decaying factor Q_{decay} ranges in value between 1 and 0, and decreases in relation to elapsed time since the previously determined quality index Q_{new} was determined. FIG. 4-5 graphically shows a relationship between the decaying factor Q_{decay} 450 and time 452. The decaying factor Q_{decay} is an indication of occurrence of self-discharge in individual battery cells and other factors. The existing quality index Q_{old} is determined in accordance with the following equation: Q_{old}=Q_{new}(t−1)*Q_{decay}, wherein Q_{new}(t−1) represents the previously determined quality index.

Referring again to FIG. 3, the electric parameters determined for each of the battery cells 115 may be evaluated to determine a cell spread based on the data captured at the time of the battery assessment at block 309. The cell spread is a measure of variation in states of charge between the plurality of battery cells 115. In one embodiment, the cell spread is associated with the states of charge of the plurality of battery cells 115, may be determined as a difference between a maximum state of charge associated with the states of charge of the plurality of battery cells 115 and a minimum state of charge associated with the states of charge of the plurality of battery cells 115.

FIG. 4-6 graphically shows a relationship between the cell spread threshold 460 and the new quality index Q_{new} 462. The cell spread threshold 460 increases with a decrease in the new quality index Q_{new} 462, with the relationship between the new quality index Q_{new} 462 and the cell spread threshold 460 being a quadratic relationship. In operation, the new quality index Q_{new} 462 may be dynamically determined in accordance with Eq. 1, above, and the cell spread is also determined based on the same data. The new quality index Q_{new} 462 is used to determine the cell spread threshold 460 based on the relationship described in FIG. 4-6. As such, the cell spread threshold 460 is dynamically determined.

Referring again to FIG. 3, the new quality index Q_{new} is compared with the previously determined quality index Q_{old}, and the cell spread is compared with the dynamically determined cell spread threshold 460 at decision block 312. When the new quality index Q_{new} is less than or equal to the previously determined quality index Q_{old} or when the cell spread is less than the cell spread threshold (0), it is an indication that the most recently performed battery assessment lacks sufficient indices of quality to warrant re-evaluating states of charge of the battery cells 115 of the battery system 100. When the new quality index Q_{new} is greater than the previously determined quality index Q_{old} and when the cell spread is greater than the cell spread threshold (1), action is taken to re-evaluate the states of charge of the battery cells 115 of the battery system 100 based upon the most recently performed battery assessment. This includes determining a quantity of electrical energy (in Amp-hours) that needs to be depleted or added to each of the battery cells 115 of the battery system 100 so that the battery sections 114 are balanced with regard to the states of charge at block 314.

Stated differently, the cell spread threshold 460 is determined from the relationship shown with reference to FIG. 4-6. When the cell spread is greater than the cell spread threshold and the new quality index Q_{new} is greater than the old quality index Q_{old}, or when there is no update in progress, (i.e., there is no old quality index Q_{old},) the cell balancing is achieved with the data used to determine the new quality index Q_{new}. When the cell spread is less than the cell spread threshold and/or the new quality index Q_{new} is less than the old quality index Q_{old}, the data used to determine the new quality index Q_{new} is discarded, and the cell balancing is achieved with the data associated with the old quality index Q_{old}, or the cell charge balancing is delayed until new data is obtained. At block 320, the cell charge balancing routine executes employing the states of charge of the battery cells 115 of the battery system 100 that were determined at the time when the previously determined quality index Q_{old} was determined at block 316.

In exemplary embodiments, a dynamic balancing threshold is determined based on the quality of the charge SOC spread, as indicated by the cell spread threshold 460 determined from the relationship shown with reference to FIG. 4-6. The concept is to prevent operation that results in cell balancing that may cause an increase in the cell spread, which may otherwise occur when the new SOC spread is lower than the existing or old SOC spread. By way of example, when there is a poor quality update under a condition that includes a small SOC spread, cell balancing will not be changed in a manner that may increase cell SOC imbalance. However, when the cell SOC spread is relatively high, lower quality updates may be allowable because the error will be less than the magnitude of the calculated SOC spread at the time of the Q_{new} calculation.

Execution of the cell charge balancing routine 320 includes controlling the cell balancing system 120 to balance the battery cells 115 of the battery pack 110 by charging individual battery cells 115 and/or discharging individual battery cells 115, such that each of the battery cells 115 has the same or similar quantum of energy stored therein, as indicated by a state of charge measurement or a voltage measurement.

The cell charge balancing routine 320 may continue in the present state until battery cells 115 are completely balanced at block 322, or until the battery assessment is updated and the cell charge balancing routine 320 is restarted employing the updated battery assessment at block 324.

Overall, the cell charge balancing control routine 300 monitors, at a first timepoint, inputs from the sensors 106 associated with each of the battery cells 115 to measure an electrical parameter thereof, e.g., voltage, determines charge parameters for each of the battery cells 115 based upon the electrical parameter, and determines a quality index at the first timepoint for the charge parameters.

In exemplary embodiments, each battery pack of the battery system is individually balanced to a determined battery pack balancing point, using the cell charge balancing control routine 300. In exemplary embodiments, once each battery pack has identified a battery pack balancing point, a string balancing point for all of the battery packs in a string is determined. The string balance point is determined in a similar manner to the determination of the battery pack balancing point, as described in FIG. 2. In one embodiment, the lowest battery pack balancing point is set as the string balancing point for all of the battery packs in a string.

Referring now to FIG. 5, a flowchart of a method 500 for performing charge balancing across multiple battery packs that each includes a plurality of cells in accordance with an exemplary embodiment is shown. At block 502, the method 500 includes determining that a battery assessment of a battery system having a string of battery packs, each including a plurality of battery cells, should be performed. In exemplary embodiments, the determination may be made by one of a battery controller, a vehicle controller, a central battery system controller, or a string controller, such as those shown in FIGS. 1A-1D. In one example, the determination that a battery assessment of the battery system should be performed is based on an analysis of the electrical parameters associated with each of a plurality of cells of the battery packs in the battery system. At block 504 the method 500 includes obtaining electrical parameters associated with the plurality of cells.

At block 506, the method 500 includes calculating a battery pack balance point for each of the battery packs in the string. In exemplary embodiments, the battery pack balance point for a battery pack is calculated based on the electrical parameters associated with the plurality of cells of the battery pack. In exemplary embodiments, a battery pack controller for each battery pack is configured to calculate the battery pack balance point for each of the battery packs. Next, at block 508, the method 500 includes instructing a cell balancing system for each battery pack to balance the plurality of battery cells of the battery pack to the battery pack balance point. In an exemplary embodiment, each battery pack in a string of connected battery packs includes a cell balancing system, such as the cell balancing system 120 as shown in FIG. 1, that is configured to bring the battery cells of the battery pack to the battery pack balance point.

At block 510, the method 500 includes calculating a string balance point for the string of battery packs based on the battery pack balance points. In exemplary embodiments, the battery pack controller of each battery pack is configured to transmit the battery pack balance point for the battery pack to the battery pack controllers of other battery packs in the string. In embodiments where the battery pack controllers of the battery packs within a string transmit the pack balance point to one another, the battery pack controllers are further configured to each calculate the string balance point, based on the plurality of battery pack balance points.

In exemplary embodiments, the battery pack controller of each battery pack is configured to transmit the battery pack balance point for the battery pack to a string controller associated with the string. In exemplary embodiments, the string controller is configured to calculate the string balance point for the string of battery packs based on the battery pack balance points and to transmit the string balance point to the battery pack controllers. In exemplary embodiments, the battery pack controller of each battery pack is configured to transmit the battery pack balance point for the battery pack to a central battery system controller. In exemplary embodiments, the central battery system controller is configured to calculate the string balance point for the string of battery packs based on the battery pack balance points.

At block 512, the method 500 includes instructing the cell balancing system of each battery pack to balance the plurality of battery cells of the battery pack to the string balance point. In an exemplary embodiment, each battery pack in a string of connected battery packs includes a cell balancing system, such as the cell balancing system 120 as shown in FIG. 1, that is configured to bring the battery cells of the battery pack to the string balance point.

In exemplary embodiments, a battery pack may not balance to its own calculated balance point, as shown at block 508, before receiving the instruction to balance to a different balance point, as shown at block 512. In one embodiment, once a battery pack has calculated its balance point, the battery pack constantly checks whether one of the other battery packs in the same string has a lower balance point. If that is the case, then the current pack will start balancing to that other packs balance point, even if the current pack hasn't balanced to its own balance point or if it is currently balancing to its own balance point. For example, battery pack A calculates its own balance point and before battery pack A begins balancing its battery cells, battery pack A determines that the balance point of pack B is lower (higher AHr difference to balanced) and so battery pack A balances its cells directly to pack B's balance point. In this example, pack A does not ever balance the cells to its own calculated balance point, only to pack B's balance point. In another example, battery pack A calculates its own balance point and begins to discharge its cells to reach that balance point. Battery pack A then detects that pack B has a lower balance point. Battery pack A then lowers its balance point and continues discharging cells, but now to the balance point of pack B. In this case, battery pack A starts balancing cells to its own calculated balance point, but never finishes and ends up balancing its cells to pack B's balance point.

In exemplary embodiments, the battery controller in communication with the plurality of sensors and the cell charge balancing system, wherein the battery controller includes an instruction set that is executable to determine, at a first timepoint, a first plurality of the electrical parameters associated with the plurality of cells, determine a plurality of first charge parameters associated with the plurality of cells based upon the respective first plurality of electrical parameters, and determine a first quality index based upon the plurality of first charge parameters. The instruction set is further executable to determine, at a second timepoint subsequent to the first timepoint, a second plurality of the electrical parameters associated with the plurality of cells, determine a plurality of second charge parameters associated with the plurality of cells based upon the respective second plurality of electrical parameters, and determine a second quality index based upon the plurality of second charge parameters. The first and second quality indices are compared. A cell charge balancing routine is executed to control the balancing system based upon the first quality index when the first quality index is greater than the second quality index, and control the cell charge balancing system based upon the second quality index when the first quality index is less than the second quality index.

Although the battery system 100 disclosed herein is primarily discussed as being part of an electric vehicle, those of ordinary skill in the art will appreciate that the battery system 100 may be disposed in a variety of other environments. In one example, the battery system 100 may be disposed in a train or locomotive. In another example, the battery system 100 may be disposed in a building, such as a home or office, and may be configured to provide power to the building.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that compares an actual or standard measurement associated with a device or system with a perceived or observed measurement or a commanded position for the device or system. A calibration as described herein can be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter can have a discrete value, e.g., either “1” or “0”, or can be infinitely variable in value.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for charge balancing in a battery system having a string of battery packs that each include a plurality of battery cells, comprising:
obtaining electrical parameters for each of the plurality of battery cells;
calculating a battery pack balance point for each of the battery packs in the string;
instructing a cell balancing system to execute a cell charge balancing routine to balance each of the plurality of battery cells of each battery pack to the battery pack balance point corresponding to the battery pack;
calculating a string balance point for the string of battery packs based on the battery pack balance points; and
instructing the cell balancing system of each battery pack to balance the plurality of battery cells of the battery pack to the string balance point.

2. The method of claim 1, wherein the battery packs of the string are connected to one another in series.

3. The method of claim 1, wherein each battery pack includes a battery pack controller and wherein the battery pack controller is configured to calculate the battery pack balance point for the battery pack.

4. The method of claim 3, wherein the battery pack controller of each battery pack is configured to transmit the battery pack balance point for the battery pack to the battery pack controllers of other battery packs in the string.

5. The method of claim 3, wherein the battery pack controller of each battery pack is configured to transmit the battery pack balance point for the battery pack to a string controller associated with the string.

6. The method of claim 5, wherein the string controller is configured to calculate the string balance point for the string of battery packs based on the battery pack balance points and to transmit the string balance point to the battery pack controllers.

7. The method of claim 3, wherein the battery pack controller of each battery pack is configured to transmit the battery pack balance point for the battery pack to a central battery system controller, wherein the central battery system controller is configured to calculate the string balance point for the string of battery packs based on the battery pack balance points.

8. A battery system, the battery system comprising:
a plurality of strings, each of the plurality of strings including a plurality of battery packs connected to one another in series, wherein each of the plurality of battery pack includes:
a plurality of battery cells;
sensors configured to monitor electrical parameters of each of the plurality of battery cells;
a cell balancing system configured to selectively charge or discharge the plurality of battery cells of the battery pack; and
a battery pack controller configured to monitor the electrical parameters for each of the plurality of battery cells and to responsively control operation of the cell balancing system,
wherein the battery pack controller is further configured to calculate a battery pack balance point based on the electrical parameters of each of the plurality of battery cells.

9. The battery system of claim 8, further comprising a central battery system controller that is configured to communicate with the battery pack controller of each of the battery packs of the plurality of strings.

10. The battery system of claim 9, wherein the central battery system controller is configured to calculate a string balance point for each of the plurality of strings of battery packs based on the battery pack balance points and to transmit a corresponding string balance point to the battery pack controller of each battery pack.

11. The battery system of claim 10, wherein the battery pack controller of each battery pack is configured to the cell balancing system of each battery pack to balance the plurality of battery cells of the battery pack to the string balance point.

12. The battery system of claim 8, further comprising a string controller associated with one of the plurality of strings, wherein the string controller is configured to communicate with the battery pack controller of each of the battery packs of the one of the plurality of strings.

13. The battery system of claim 12, wherein the string controller is configured to calculate a string balance point for the one of the plurality of strings and to transmit the string balance point to the battery pack controller of each battery pack of the one of the plurality of strings.

14. The battery system of claim 13, wherein the battery pack controller of each battery pack is configured to the cell balancing system of each battery pack to balance the plurality of battery cells of the battery pack to the string balance point.

15. The battery system of claim 8, wherein the battery pack controller of each battery pack of one of the plurality of strings is configured to transmit the battery pack balance point to the battery pack controllers of other battery packs in one of the plurality of strings.

16. An electric vehicle comprising:
a battery system having a plurality of strings, each of the plurality of strings including a plurality of battery packs connected to one another in series, wherein each of the plurality of battery pack includes:
a plurality of battery cells;
sensors configured to monitor electrical parameters of each of the plurality of battery cells;
a cell balancing system configured to selectively charge or discharge the plurality of battery cells of the battery pack; and
a battery pack controller configured to monitor the electrical parameters for each of the plurality of battery cells and to responsively control operation of the cell balancing system,
wherein the battery pack controller is further configured to calculate a battery pack balance point based on the electrical parameters of each of the plurality of battery cells.

17. The electric vehicle of claim 16, wherein the battery system further comprises a central battery system controller that is configured to communicate with the battery pack controller of each of the battery packs of the plurality of strings.

18. The electric vehicle of claim 17, wherein the central battery system controller is configured to calculate a string balance point for each of the plurality of strings of battery packs based on the battery pack balance points and to transmit a corresponding string balance point to the battery pack controller of each battery pack.

19. The electric vehicle of claim 18, wherein the battery pack controller of each battery pack is configured to the cell balancing system of each battery pack to balance the plurality of battery cells of the battery pack to the string balance point.

20. The electric vehicle of claim 16, wherein the battery system further comprises a string controller associated with one of the plurality of strings, wherein the string controller is configured to communicate with the battery pack controller of each of the battery packs of the one of the plurality of strings.
